(19) United States
(12) Patent Application Publication
(10) Pub. No.: US 2011/0080272 A1
(43) Pub. Date: Apr. 7, 2011

(54) MOUSE EXPELLER

(76) Inventor: Chih-Hsien Wu, Taipei City (TW)

(21) Appl. No.: 12/698,146

(22) Filed: Feb. 2, 2010

(30) Foreign Application Priority Data
Oct. 7, 2009 (TW) 098212660

(51) Int. Cl. G08B 3/10

(52) U.S. Cl. 340/384.2

(57) ABSTRACT

The mouse expeller contains a casing member, a control circuit inside the casing member, and at least a set of pressurized audio or ultrasonic speakers also inside the casing member and connected to the control circuit. The speaker is positioned at an end of a tubular body made of a metallic or plastic material functioning as a resonant chamber so as to boost the sound power for an enhanced coverage area. At least a variable resistor is configured on the control circuit which is manually adjustable from outside the casing member so as to vary the output frequency of oscillator ICs. As such, the mouse expeller is able to produce a sound wave at various frequencies without the issue that the mice would get used to the sound wave.

### TECHNICAL FIELD OF THE INVENTION

The present invention generally relates to ultrasonic mouse expellers, and especially relates to an ultrasonic mouse expeller providing boosted audio or ultrasonic sound with variable frequencies to achieve enhanced expelling effect.

### DESCRIPTION OF THE PRIOR ART

Mice are harmful animals that would destroy furniture and farm products, stealing food, and dissimilating diseases. To expel such harmful animals, there is a need for development of mouse expellers and mouse poisons.

A conventional ultrasonic mouse expeller uses an oscillation circuit to generate a sound wave of an ultrasonic frequency so as to make mice in the vicinity to feel uncomfortable and escape. This type of conventional mouse expeller employs a single-frequency ultrasonic transducer which is capable of producing high-power sound wave. Yet, only a single sound wave pattern of the same frequency is generated. After a period of use, mice would get used to the sound wave pattern and the expelling effect is diminished. Some of the mouse expellers that adopt a microprocessor to produce random control would use ultrasonic transducer that can output multi frequencies or auto sweep or ceramic buzzer. However, due to the continuous change of the sound wave pattern, such mouse expellers have a common drawback that the sound power is too low to cover a large area.

### SUMMARY OF THE INVENTION

Therefore, a major object of the present invention is to provide a resonant chamber in the mouse expeller so as to provide variable frequency control to the mouse expeller so that sound waves of various frequencies could be produced to restrain the inertia of mice.

Another object of the present invention is to provide a resonant chamber in the mouse expeller, which has a high-power sound waves and the volume can be adjusted and controlled.

To achieve the above objects, the mouse expeller contains a casing member, which includes a plurality of audio frequency oscillator ICs, a variable resistor, a plurality of capacitors, transistors and resistors, a light emitting diode, a switch, a power connector, at least a set of pressurized audio/ultrasonic speakers, and a power adaptor.

The speaker is positioned at an end of a tubular body made of a metallic or plastic material functioning as a resonant chamber so as to boost the sound power for an enhanced coverage area.

At least a variable resistor is configured on the control circuit which is manually adjustable from outside of the casing member so as to vary the output frequency of an oscillator IC. As such, the mouse expeller is able to produce a sound wave at various frequencies without the issue that the mice would get used to the sound wave. The present invention is characterized at that:

1. a resonance effect can be generated via the speaker members through the close tubular body, and subsequently enhance the sound pressure to accomplish the purpose of expelling mice; and

2. tubular bodies of various materials can provide different sound frequencies but remain the same sound pressure.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a mouse expeller according to a first embodiment of the present invention.

FIG. 2 is a perspective view of the mouse expeller of FIG. 1 after assembly.

FIG. 3 is a perspective view showing the back of the mouse expeller of FIG. 1.

FIG. 4 is a perspective view showing a mouse expeller according to a second embodiment of the present invention.

FIG. 5 is a circuit diagram showing a control circuit adopted by the mouse expeller according to first embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

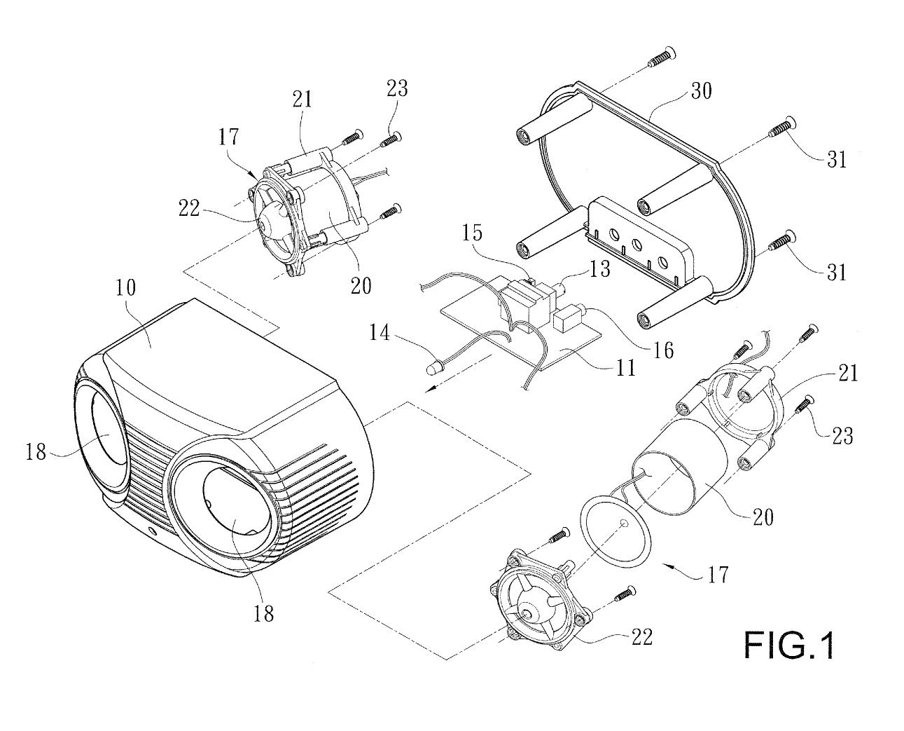

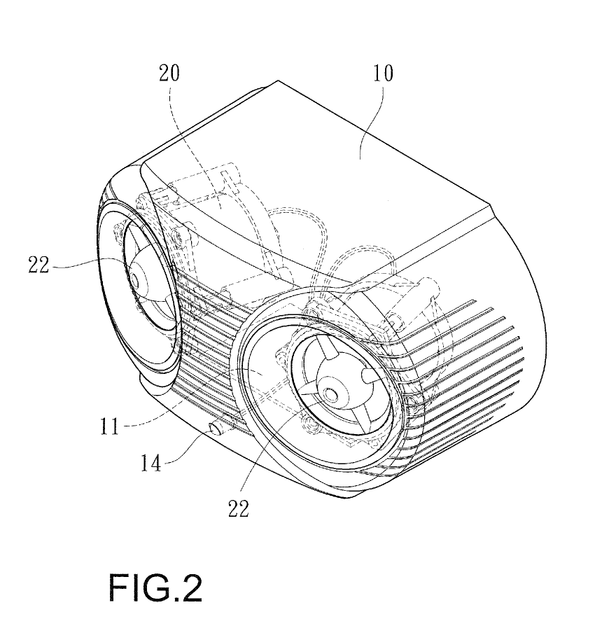

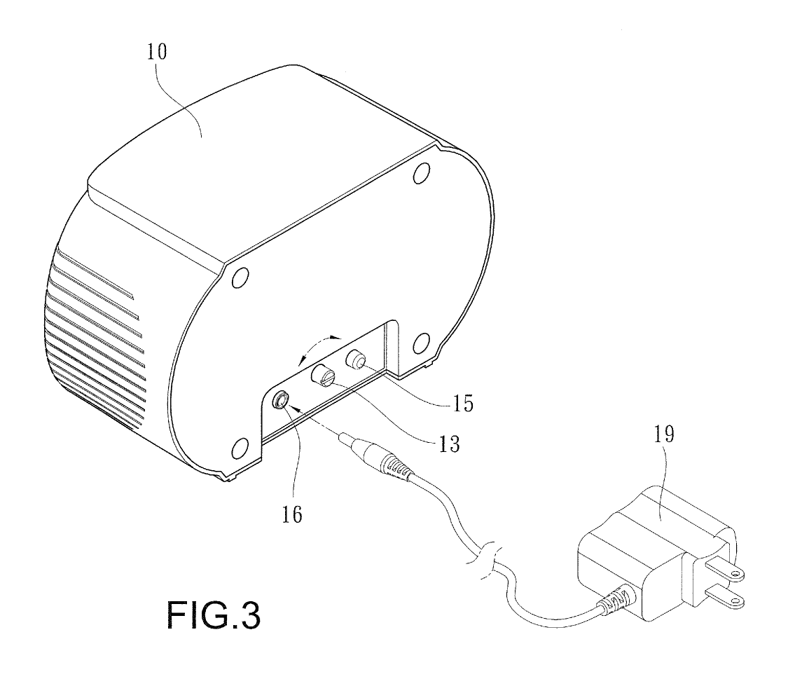

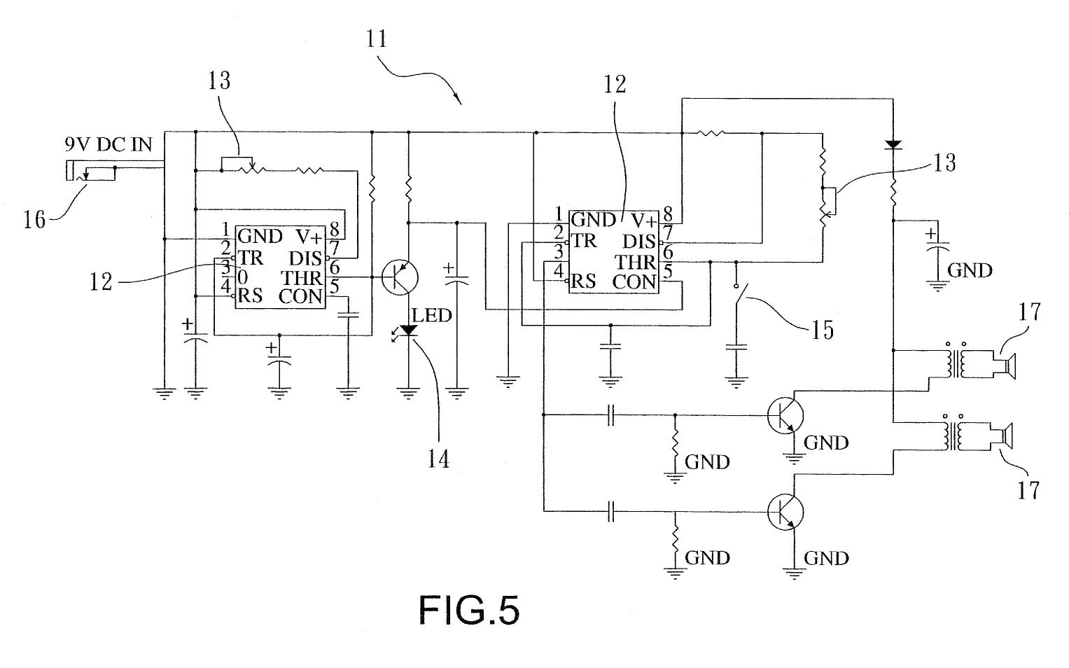

As shown in FIGS. 1, 2, and 5, a mouse expeller according to a first embodiment of the present invention contains a casing member 10 and a control circuit 11 housed inside the casing member 10. The casing member 10 has an open back side sealed by a cover 30 and fixed by a number of bolts 31. The control circuit 11, as shown in FIG. 5, contains two audio-frequency oscillator ICs 12, variable resistors 13, a number of capacitors, transistors, resistors, a light emitting diode (LED) 14, a switch 15, and a power connector 16. Also housed inside the casing member 10 and connected to the control circuit 11 are two speaker members 17. Each speaker member 17 contains a pressurized audio speaker or a pressurized ultrasonic speaker positioned at an end of a tubular body 20. A front cap 22 in front of the speaker and a back cap 21 at the other end of the tubular body 20 are joined by a number of bolts 23, sandwiching the speaker and the tubular body 20. The LED 14 is exposed from a front side of the casing member 10. Similarly, the front caps 22 of the speaker members 17 are also exposed from two openings 18 on the front side of the casing member 10. The variable resistors 13, the switch 15, and the power connector 16 are, on the other hand, exposed out of the cover 30, as shown in FIG. 3. Each tubular body 20 forms a resonant chamber for the speaker and is preferably made of aluminum In alternative embodiments, the tubular body 20 could also be made of plastic or copper.

As shown in FIG. 3, the power connector 16 is connected to a power adaptor 19 which is plugged into a wall socket so as to draw electricity to drive the control circuit 11. The variable resistors 13 provide manual adjustment to the audio-frequency oscillator ICs 12 to produce signals of desired frequencies. The signals are then delivered to the speakers of the speaker member 17 to generate audio or ultrasonic sounds to expel mice. The sound power is further boosted by the resonant chambers formed by the tubular bodies 20 so as to enhance the expelling effect.

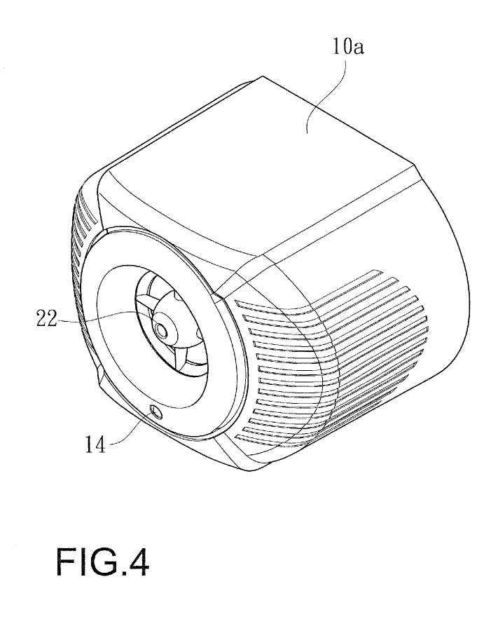

FIG. 4 provides a second embodiment of the mouse expeller according to the present invention. As illustrated, the mouse expeller has a casing member 10a and a same control circuit (not shown) as the previous embodiment housed inside. However, the control circuit contains a single audio-frequency oscillator IC 12 and a single speaker member 17. The speaker member 17 also contains a pressurized audio speaker or a pressurized ultrasonic speaker. A LED 14 is also exposed from the front side of the casing member 10. The present embodiment is appropriate for expelling mice in a smaller space.

Compared to conventional mouse expellers, the present invention has the following advantages. First of all, the sound frequency could be manually and easily adjusted so that, when a user is not comfortable with a particular frequency, he or she could conveniently switches to another frequency. In addition, a resonant chamber is included to boost the sound power so that the expelling effect is further enhanced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mouse expeller, comprising:
a casing member;
a control circuit inside said casing member, having at least an oscillator IC, a variable resistor, a plurality of capacitors, transistors and resistors, a light emitting diode, a switch, and a power connector; and
at least a set of speaker members inside said casing member, each having a pressurized speaker positioned at an end of a tubular body where said speaker and said tubular body are sandwiched between a front cap and a back cap so that said tubular body functions as a resonant chamber;
wherein said variable resistor, speaker, switch, and power connector are exposed out of said casing member; said power connector is for connecting to a power adaptor; and said variable resistor is for manual adjustment of the output frequency of said oscillator IC.

2. The mouse expeller according to claim 1, wherein said tubular body is made of a metallic material.

3. The mouse expeller according to claim 1, wherein said tubular body is made of a plastic material.

4. The mouse expeller according to claim 1, wherein said pressurized speaker is a pressurized ultrasonic speaker.
